(19) United States
(12) Patent Application Publication
(10) Pub. No.: US 2008/0122775 A1
(43) Pub. Date: May 29, 2008

(54) DISPLAY APPARATUS

(76) Inventors: Sang-Il Kim, Yongin-si (KR); Seong-Sik Shin, Seongnam-si (KR); Hee-Seop Kim, Hwaseong-si (KR); Young-Chol Yang, Seongnam-si (KR)

Correspondence Address: F. CHAU & ASSOCIATES, LLC, 130 WOODBURY ROAD, WOODBURY, NY, 11797, US

(21) Appl. No.: 11/928,501

(22) Filed: Oct. 30, 2007

(30) Foreign Application Priority Data
Nov. 23, 2006 (KR) 10-2006-116493

(51) Int. Cl. G09G 3/36

(52) U.S. Cl. 345/94

(57) ABSTRACT

In a display apparatus, a common electrode receives a common voltage of which a voltage level is inverted at every H/2 period of 1H period during which pixels connected to one row are turned on. A first switching device outputs a first data voltage having a voltage level different from the common voltage during an earlier H/2 period, and a second switching device outputs a second data voltage having a polarity different from the first data voltage during a later H/2 period. First and second pixel electrodes receive the first and second data voltages from the first and second switching devices, respectively. Thus, a liquid crystal voltage applied to a liquid crystal layer increases, thereby improving a response speed of a liquid crystal and reducing a power consumption of the display apparatus.

### CROSS-REFERENCE TO RELATED APPLICATION

This application relies for priority upon Korean Patent Application No. 2006-116493 filed on Nov. 23, 2006, the contents of which are herein incorporated by reference in its entirety.

### BACKGROUND OF THE INVENTION

1. Technical Field

The present disclosure relates to a display apparatus. More particularly, the present disclosure relates to a display apparatus capable of having a reduced power consumption.

2. Discussion of Related Art

In general, a liquid crystal display (LCD) includes an array substrate, a color filter substrate, and a liquid crystal layer. The color filter substrate includes a common electrode to which a common voltage is applied, and the array substrate receives a pixel voltage having a different voltage level from the common voltage.

Thus, a fringe electric field is generated between the array substrate and the color filter substrate caused by a voltage difference between the common voltage and the pixel voltage, and the liquid crystal molecules included in the liquid crystal layer are rotated by this fringe electric field.

A rotation rate of the liquid crystal molecules is varied according to an intensity of the fringe electric field. That is, as the intensity of the fringe electric field increases, the rotation rate of the liquid crystal molecules increases, so that a response speed and a transmittance of the LCD also increase.

In a conventional LCD, however, because one pixel area includes only one pixel electrode, the fringe electric field is generated only between the array substrate and the color filter substrate. Therefore, there is a limitation on improving the response speed and the transmittance of the LCD.

### SUMMARY OF THE INVENTION

Exemplar embodiments of the present invention provide a liquid crystal display capable of reducing power consumption without increasing a driving voltage.

In an exemplary embodiment of the present invention, a display apparatus includes a plurality of pixels to display an image, and each of the pixels includes a common electrode, a first switching device, a second switching device, a first pixel electrode, a second pixel electrode, and a liquid crystal layer.

The common electrode receives a common voltage, a voltage level of which is changed every half period (hereinafter, referred to as H/2 period) of a horizontal scanning period (hereinafter referred to as 1H period) during which pixels connected to one row are turned on. The first switching device outputs a first data voltage having a different voltage level from a voltage level of the common voltage in response to a first gate signal during an earlier H/2 period of the 1H period, and the second switching device outputs a second data voltage having a different polarity from a polarity of the first data voltage with reference to the common voltage in response to a second gate signal during a later H/2 period of the 1H period.

The first pixel electrode is electrically connected to an output electrode of the first switching device to receive the first data voltage, and the second pixel electrode is electrically insulated from the first pixel electrode and connected to an output electrode of the second switching device to receive the second data voltage. The liquid crystal layer is interposed between the common electrode and the first and second pixel electrodes.

According to the above-described exemplary embodiment, because the common voltage having a square wave form that swings every H/2 period is applied to the common electrode, and the first and second data voltages having different polarities from each other are applied to the first and second pixel electrodes every H/2 period, respectively, a liquid crystal voltage applied to the liquid crystal layer interposed between the common electrode and the first and second pixel electrodes may be increased, thereby increasing a response speed of the liquid crystal and reducing a power consumption of the display apparatus.

### BRIEF DESCRIPTION OF THE DRAWINGS

Exemplary embodiments of the present invention will be understood in more detail from the following descriptions taken in conjunction with the accompanying drawings, wherein:

FIG. 1 is an equivalent circuit diagram showing an exemplary embodiment of a pixel of a dual-field switching mode liquid crystal display according to the present invention;

FIG. 2 is a waveform diagram showing signals applied to the pixel of FIG. 1;

FIGS. 3 and 4 are sectional views showing the dual-field switching mode liquid crystal display of FIG. 1;

FIG. 5 is a layout showing the pixel of FIG. 1;

FIG. 6 is a sectional view showing an exemplary embodiment of a patternless dual-field switching mode liquid crystal display according to the present invention;

FIG. 7 is a sectional view showing an exemplary embodiment of a patterned vertical alignment mode liquid crystal display according to the present invention; and

FIG. 8 is a sectional view showing an exemplary embodiment of a plane-to-line switching mode liquid crystal display according to the present invention.

### DESCRIPTION OF EXEMPLARY EMBODIMENTS

Hereinafter exemplary embodiments of the present invention will be explained in detail with reference to the accompanying drawings.

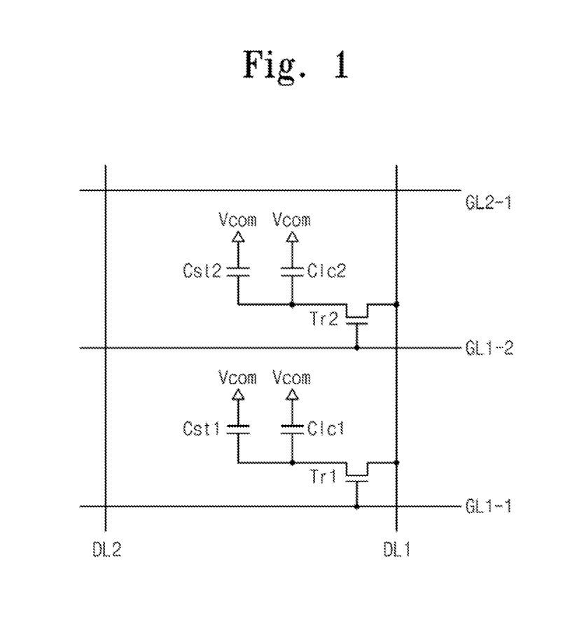

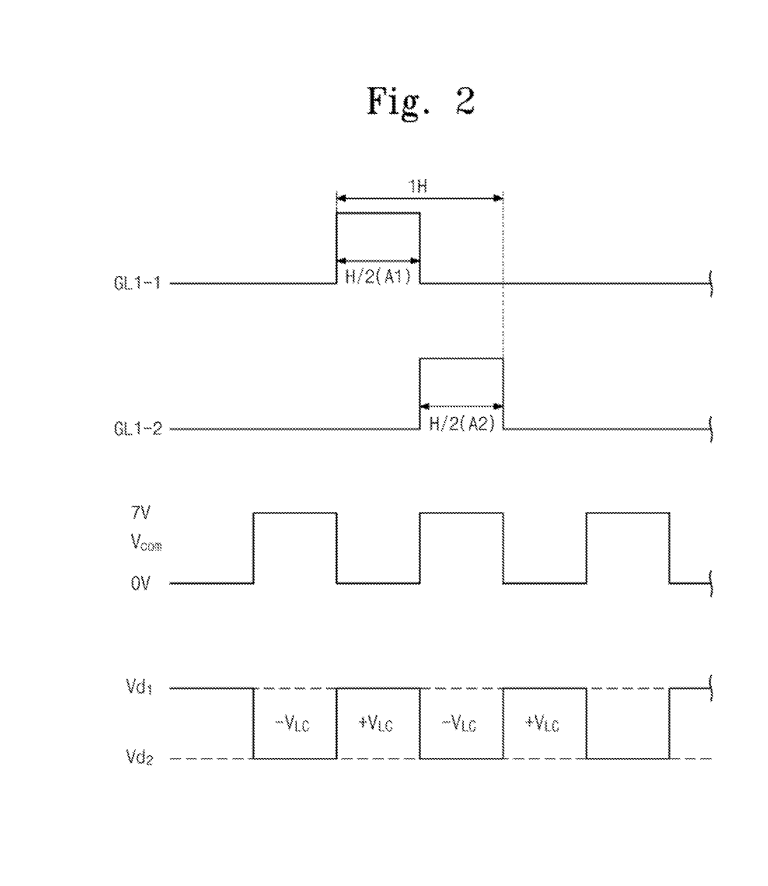

FIG. 1 is an equivalent circuit diagram showing an exemplary embodiment of a pixel of a dual-field switching mode liquid crystal display according to the present invention, and FIG. 2 is a waveform diagram showing signals applied to the pixel of FIG. 1.

Referring to FIG. 1, in a dual-field switching (DFS) mode liquid crystal display (LCD), a pixel includes a first gate line GL1-1, a second gate line GL1-2, a first data line DL1, a first thin film transistor Tr1, a second thin film transistor Tr2, a first liquid crystal capacitor clc1, a second liquid crystal capacitor Clc2, a first storage capacitor Cst1, and a second storage capacitor Cst2.

The first thin film transistor Tr1 is electrically connected to the first gate line GL1-1 and the first data line DL1, and the first liquid crystal capacitor Clc1 and the first storage capacitor Cst1 are connected in parallel to a drain electrode of the first thin film transistor Tr1. A first electrode of the first liquid crystal capacitor Clc1 serves as a first pixel electrode, and a second electrode of the first liquid crystal capacitor Clc1 serves as a common electrode. Also, a first electrode of the first storage capacitor Cst1 serves as the first pixel electrode and a second electrode of the first storage capacitor Cst1 serves as a storage line.

The second thin film transistor Tr2 is electrically connected to the second gate line GL1-2 and the first data line DL1, and the second liquid crystal capacitor Clc2 and the second storage capacitor Cst2 are connected in parallel to a drain electrode of the second thin film transistor Tr2. A first electrode of the second liquid crystal capacitor Clc2 serves as a second pixel electrode, and a second electrode of the second liquid crystal capacitor Clc2 serves as the common electrode. The second pixel electrode is electrically insulated from the first pixel electrode. Also, a first electrode of the second storage capacitor Cst2 serves as the second pixel electrode and a second electrode of the second storage capacitor Cst2 serves as the storage line.

As shown in FIG. 2, when a period during which one pixel is driven is defined as a 1H period, a first gate signal in a high state is applied to the first gate line GL1-1 during an earlier H/2 period A1 of the 1H period, and a second gate signal in a high state is applied to the second gate line GL1-2 during a later H/2 period A2 of the 1H period.

A common voltage Vcom is applied to the common electrode that serves as the second electrode of the first and second liquid crystal capacitors Clc1 and Clc2 as a reference voltage. The common voltage Vcom has a squarewave form in which a voltage level is changed at every H/2 period. In the present exemplary embodiment, the common voltage Vcom is a squarewave voltage that swings between 0V and 7V. The common voltage Vcom has a period equal to the 1H period and a duty ratio of about 50%.

A first data voltage Vd1 having a higher voltage level than that of the common voltage Vcom is applied to the first data line DL1 during the earlier H/2 period A1, and a second data voltage Vd2 having a lower voltage level than that of the common voltage Vcom is applied to the first data line DL1 during the later H/2 period A2.

More specifically, the first thin film transistor Tr1 provides the first data voltage Vd1 to the first pixel electrode in response to the first gate signal during the earlier H/2 period A1. Thus, a liquid crystal voltage +V_{LC} having a positive polarity is charged to the first liquid crystal capacitor Clc1 by the first data voltage Vd1 and the common voltage Vcom.

The second thin film transistor Tr2 provides the second data voltage Vd2 to the second pixel electrode in response to the second gate signal during the later H/2 period A2. Thus, a liquid crystal voltage −V_{LC} having a negative polarity is charged to the second liquid crystal capacitor Clc2 by the second data voltage Vd2 and the common voltage Vcom.

The first data voltage Vd1 and the second data voltage Vd2 having opposite polarities to each other are sequentially applied to the first pixel electrode and the second pixel electrode during the earlier and later H/2 periods, respectively. Therefore a polarity may be inverted at every pixel/2 or less, and as a result a flickering phenomenon may be reduced.

Also, since the common voltage Vcom has the squarewave form that swings according to the variation of polarities of the first and second data voltages Vd1 and Vd2, a size of a liquid crystal voltage V_{LC} may be increased without increasing a driving voltage of the dual-field switching (DFS) mode LCD. Thus, a power consumption of the DFS mode LCD may be reduced.

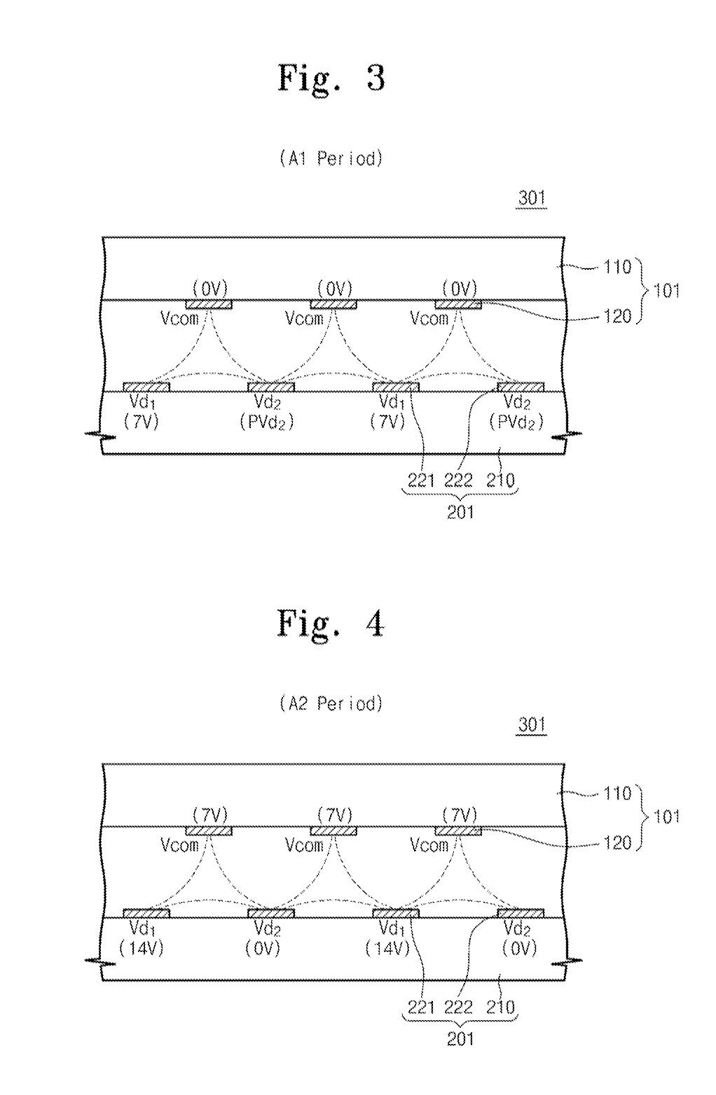

FIGS. 3 and 4 are sectional views showing the DFS mode LCD of FIG. 1.

Referring to FIGS. 3 and 4, a DFS mode LCD 301 includes a first display substrate 101, a second display substrate 201 and a liquid crystal layer (not shown). The second display substrate 201 is combined with the first display substrate 101 and faces the first display substrate 101. The liquid crystal layer (not shown) is interposed between the first display substrate 101 and the second display substrate 201 and includes a plurality of liquid crystal molecules.

The first display substrate 101 includes a first base substrate 110 and a common electrode 120 that is formed on the first base substrate 110. The common voltage Vcom shown in FIG. 2 is applied to the common electrode 120. In the present exemplary embodiment, the common voltage Vcom is the squarewave voltage that swings between 0V and 7V. The common electrode 120 includes a plurality of subcommon electrodes spaced apart from each other by a predetermined distance. The subcommon electrodes have a width that is equal to or smaller than the distance therebetween.

Although not shown in FIG. 3, the first display substrate 101 may further include a black matrix and a color filter layer. The black matrix and the color filter layer are interposed between the first base substrate 110 and the common electrode 120.

The second display substrate 201 includes a second base substrate 210 and the first pixel electrode 221, and the second pixel electrode 222. The first pixel electrode 221 and the second pixel electrode 222 are alternately arranged on the second base substrate 210. More specifically, the first pixel electrode 221 is located between two adjacent second pixel electrodes 222, and the second pixel electrode 222 is located between two adjacent first pixel electrodes 221. Each of the first pixel electrode 221 and the second pixel electrode 222 has a width that is equal to or smaller than the distance between the first pixel electrode 221 and the second pixel electrode 222. Also, the common electrode 120 is formed in a region located between the first pixel electrode 221 and the second pixel electrode 222. Thus, the common electrode 120 is not overlapped with the first pixel electrode 221 and the second pixel electrode 222.

As shown in FIGS. 2 and 3, the common voltage Vcom maintains a voltage level of about 0V during the earlier H/2 period A1 and a first data voltage Vd1 having the higher voltage level than that of the common voltage Vcom is applied to the first pixel electrode 221. As an example of the present exemplary embodiment, the first data voltage Vd1 has a voltage level of about 7V. Meanwhile, the second pixel electrode 222 maintains a second previous data voltage PVd2 applied in a previous frame during the earlier H/2 period A1. In case that the first data voltage Vd1 and a second data voltage Vd2 are inverted at every one frame, the second previous data voltage has a voltage level of about 14V.

Thus, during the earlier H/2 period A1, a first fringe electric field of about 7V is generated between the common electrode 120 and the first pixel electrode 221, a second fringe electric field of about 14V is generated between the common electrode 120 and the second pixel electrode 222, and a lateral electric field of about 7V is generated between the first pixel electrode 221 and the second pixel electrode 222.

As shown in FIG. 4, the voltage level of the common voltage Vcom increases to about 7V during the later H/2 period A2. At this time, the first data voltage Vd1 applied to the first pixel electrode 221 increases from about 7V to about 14V, so an electric potential difference between the common voltage Vcom and the first data voltage Vd1 is maintained. The second data voltage Vd2 having the tower voltage level than that of the common voltage Vcom is applied to the second pixel electrode 222 during the later H/2 period A2. As an example of the present exemplary embodiment, the second data voltage has a voltage level of about 0V.

Thus, during the later H/2 period A2, the first fringe electric field of about 7V is generated between the common electrode 120 and the first pixel electrode 221, the second fringe electric field of about 7V is formed between the common electrode 120 and the second pixel electrode 222, and the lateral electric field of about 14V is generated between the first pixel electrode 221 and the second pixel electrode 222.

Because the first and second fringe electric fields are generated between the first display substrate 101 and the second display substrate 201 and the lateral electric field is generated in the second display substrate 201, the response speed of the liquid crystal molecules may be improved. Also, because the first and second fringe electric fields and the lateral electric field have a voltage level greater than two times the voltage level applied to the common electrode 120, the first pixel electrode 221, and the second pixel electrode 222, the power consumption of the DFS mode LCD 301 may be reduced.

Although not shown in the figures, the first display substrate 101 further includes a first horizontal alignment film formed on the common electrode 120, and the second display substrate 201 further includes a second horizontal alignment film formed on the first and second pixel electrodes 221 and 222. Thus, the liquid crystal molecules are aligned in parallel with the first and second display substrates 101 and 201 during an initial state when no voltage is applied to the common electrode 120, the first pixel electrode 221, and the second pixel electrode 222.

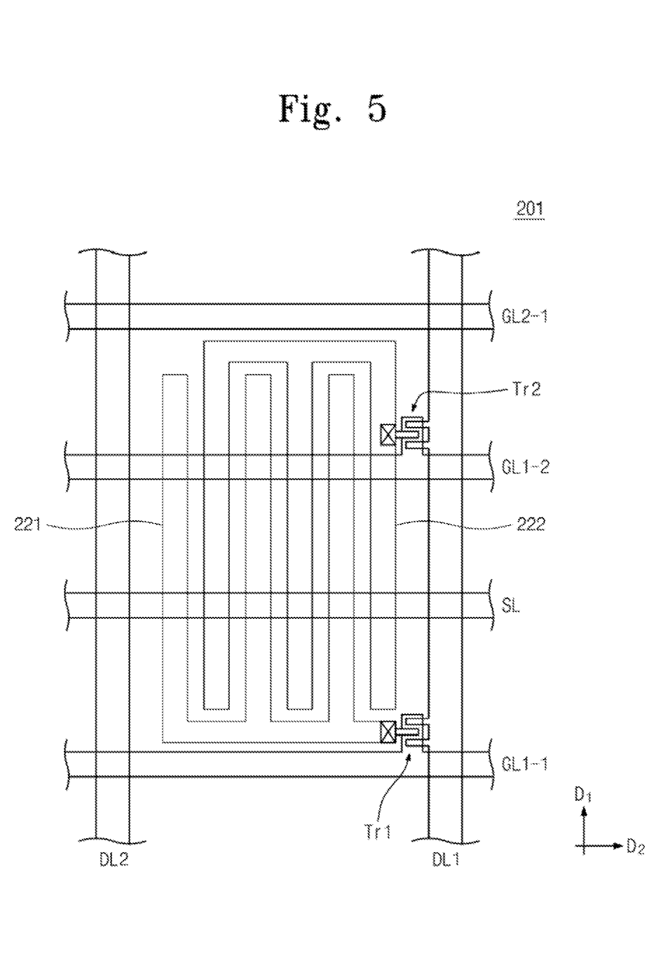

Hereinafter, the second display substrate 201 will be described in detail with reference to FIG. 5.

FIG. 5 is a plan view showing an exemplary embodiment of a pixel arranged in a second display substrate according to the present invention.

Referring to FIG. 5; the second display substrate 201 includes the first data line DL1, the second data line DL2, the first gate line GL1-1, the second gate line GL1-2, and the third gate line GL2-1. The first and second data lines DL1 and DL2 extend in a first direction D1, and the first, second, and third gate lines GL1-1, GL1-2, and GL2-1 extend in a second direction D2 substantially perpendicular to the first direction D1. The pixel area is defined on the second display substrate 201 by the first and second data lines DL1 and DL2 and the first, second, and third gate lines GL1-1, GL1-2, and GL2-1 to have a rectangular shape. The second gate line GL1-2 is arranged between the first gate line GL1-1 and the third gate line GL2-1 to cross the pixel area.

The second display substrate 201 includes the first thin film transistor Tr1, the second thin film transistor Tr2, the first pixel electrode 221, and the second pixel electrode 222 arranged in the pixel area. The first thin film transistor Tr1 is electrically connected to the first gate line GL1 and the first data line DL1, and the second thin film transistor Tr2 is electrically connected to the second gate line GL1-2 and the first data line DL1.

More specifically, the first thin film transistor Tr1 includes a gate electrode branched from the first gate line GL1-1, a source electrode branched from the first data line DL1, and a drain electrode electrically connected to the first pixel electrode 221. The first pixel electrode 221 serves as the first electrode of the first liquid crystal capacitor Clc1 shown in FIG. 1.

The second thin film transistor Tr2 includes a gate electrode branched from the second gate line GL1-2, a source electrode branched from the first data line DL1, and a drain electrode electrically connected to the second pixel electrode 222. The second pixel electrode 222 serves as the first electrode of the second liquid crystal capacitor Clc2 shown in FIG. 1.

The first pixel electrode 221 and the second pixel electrode 222 are spaced apart from each other by a predetermined distance and insulated from each other. The first and second pixel electrodes 221 and 222 extend in the first direction D1 substantially in parallel with the first and second data lines DL1 and DL2. The second horizontal alignment film formed on the second display substrate 201 is rubbed in the second direction D2, and the liquid crystal layer (not shown) interposed between the first display substrate 101 (shown in FIG. 1) and the second display substrate 201 includes a negative-type liquid crystal. In case that the second horizontal alignment film arranged on the second display substrate 201 is rubbed in the first direction D1, however, the liquid crystal layer interposed between the first display substrate 101 and the second display substrate 201 may include a positive-type liquid crystal.

Although not shown in the figures, the first and second pixel electrodes 221 and 222 may be extended in the second direction D2 substantially in parallel with the first, second, and third gate lines GL1-1, GL1-2, and GL2-1. Also, the first and second pixel electrodes 221 and 222 may be extended in a third direction that is inclined by a predetermined angle with respect to the first and second directions D1 and D2. For instance, the first and second pixel electrodes 221 and 222 may be inclined at an angle from about 5 degrees to about 30 degrees with respect to the first direction D1.

As shown in FIG. 5, the second display substrate 201 further includes a storage line SL that extends in the second direction D2 substantially in parallel with the first gate line GL1-1. The storage line SL and the first gate line GL1-1 are simultaneously formed using the same material. Thus, the storage line SL is formed in a different layer from the first and second pixel electrodes 221 and 222 and is insulated from the first and second pixel electrodes 221 and 222.

The storage line SL faces the first pixel electrode 221 to form the first storage capacitor Cst1 shown in FIG. 1 and faces the second pixel electrodes 222 to form the second storage capacitor Cst2 shown in FIG. 1.

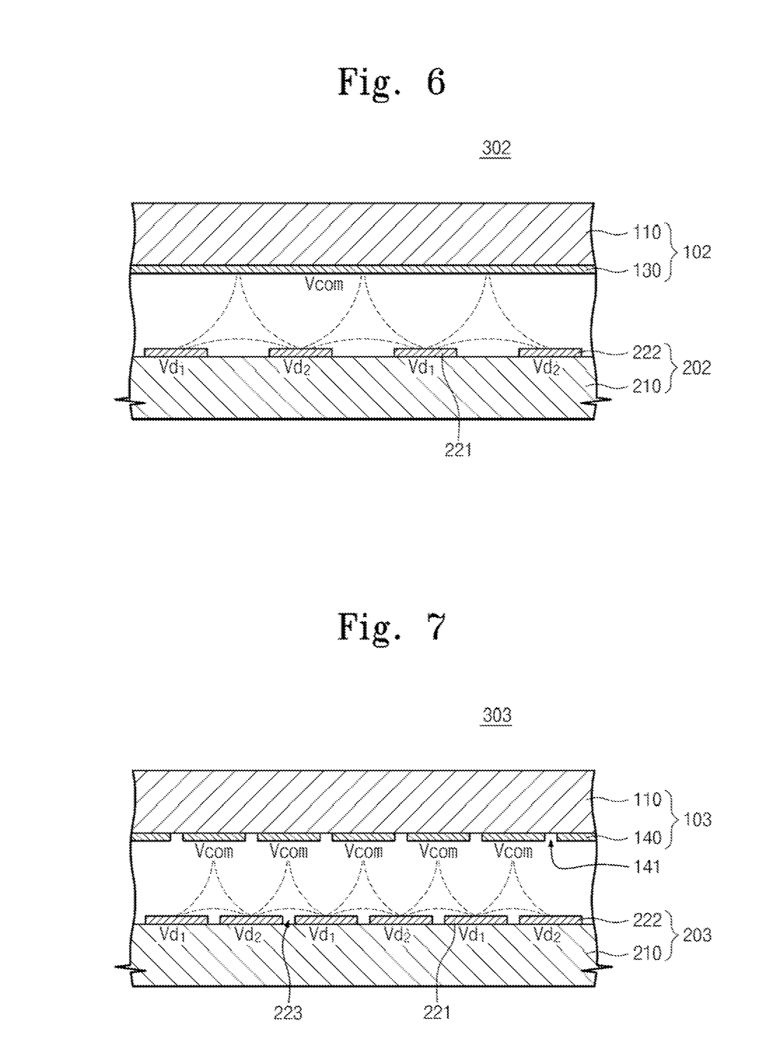

FIG. 6 is a sectional view showing a patternless DFS mode LCD according to an exemplary embodiment of the present invention.

Referring to FIG. 6, in a first display substrate 102 of a patternless DFS mode LCD 302, a common electrode 130 is not divided into a plurality of subcommon electrodes but formed over the first base substrate 110.

In the present exemplary embodiment, the second display substrate 202 has the same structure as that of the second display substrate 201 shown in FIG. 1 and, thus, detailed descriptions of the second display substrate 202 will be omitted.

As shown in FIG. 6, a common voltage Vcom having a squarewave form is applied to the common electrode 130, a first data voltage Vd1 having a higher voltage level than that of the common voltage Vcom is applied to a first pixel electrode 221, and a second data voltage Vd2 having a lower voltage level than that of the common voltage Vcom is applied to a second pixel electrode 222.

Thus, a first fringe electric field in which liquid crystal molecules are rotated by a voltage difference between the first data voltage Vd1 and the common voltage Vcom is generated between the first pixel electrode 221 and the common electrode 130. A second fringe electric field in which liquid crystal molecules are rotated by a voltage difference between the second data voltage Vd2 and the common voltage Vcom is generated between the second pixel electrode 222 and the common electrode 130. Also, a lateral electric field in which liquid crystal molecules are rotated by a voltage difference between the first data voltage Vd1 and the second data voltage Vd2 is generated between the first pixel electrode 221 and the second pixel electrode 222.

As described above, because the lateral electric field is generated in the second display substrate 202, a response speed of the liquid crystal molecules increases. Also, because the first and second fringe electric fields and the lateral electric field have a voltage level greater than two times the voltage levels applied to the common electrode 130, the first pixel electrode 221, and the second pixel electrode 222, a power consumption of the patternless DFS mode LCD 301 may be reduced.

Further, because the first data voltage Vd1 and the second data voltage Vd2 having different polarities from each other are respectively applied to the first and second pixel electrodes 221 and 222 in one pixel, the polarity may be inverted at every pixel/2 or less, thereby reducing a flickering phenomenon.

FIG. 7 is a sectional view showing a patterned vertical alignment mode LCD according to an exemplary embodiment of the present invention.

Referring to FIG. 7, a patterned vertical alignment (PVA) mode LCD 303 includes a first display substrate 103 on which a common electrode 140 is formed on a first base substrate 110 and a second display substrate 203 on which a first pixel electrode 221 and a second pixel electrode 222 are formed on a second base substrate 210. Although not shown in FIG. 7, a liquid crystal layer including a plurality of liquid crystal molecules is interposed between the first display substrate 103 and the second display substrate 203.

The common electrode 140 is provided with a first opening 141 formed therethrough, and the first and second pixel electrodes 221 and 222 are spaced apart from each other by a predetermined distance. The space between the first pixel electrode 221 and the second pixel electrode 222 is defined as a second opening 223. The first opening 141 is positioned in a region located between the two adjacent second openings 223. Thus, a plurality of domains in which alignment directions of the liquid crystal molecules are different from each other in one pixel area may be formed by the first and second openings 141 and 223.

As shown in FIG. 7, a common voltage Vcom having a squarewave form, shown in FIG. 2 is applied to the common electrode 140, a first data voltage Vd1 having a higher voltage level than that of the common voltage Vcom is applied to the first pixel electrode 221 and a second data voltage Vd2 having a lower voltage level than that of the common voltage Vcom is applied to the second pixel electrode 222.

Accordingly, a first fringe electric field in which the liquid crystal molecules are rotated by a voltage difference between the first data voltage Vd1 and the common voltage Vcom is generated between the first pixel electrode 221 and the common electrode 140. A second fringe electric field in which the liquid crystal molecules are rotated by a voltage difference between the second data voltage Vd2 and the common voltage Vcom is generated between the second pixel electrode 222 and the common electrode 140. Also, a lateral electric field in which the liquid crystal molecules are rotated by a voltage difference between the first data voltage Vd1 and the second data voltage Vd2 is generated between the first pixel electrode 221 and the second pixel electrode 222.

As described above, the first and second fringe electric fields are generated between the first display substrate 103 and the second display substrate 203, and further the lateral electric field that is stronger than the first and second fringe electric fields is generated in the second display substrate 203 by the first data voltage Vd1 and the second data voltage Vd2.

Although not shown in FIG. 7, the first display substrate 103 further includes a first vertical alignment film arranged on the common electrode 140, and the second display substrate 203 further includes a second vertical alignment film arranged on the first and second pixel electrodes 221 and 222. Thus, the liquid crystal molecules are vertically aligned during an initial state when no voltage is applied to the common electrode 140, the first pixel electrode 221, and the second pixel electrode 222.

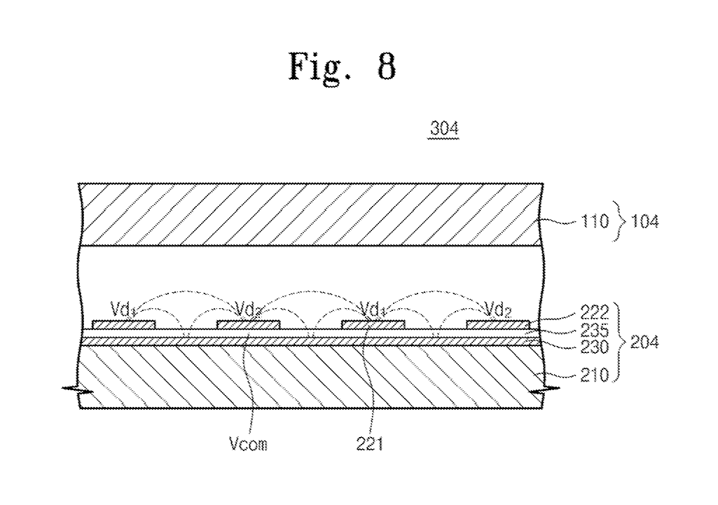

FIG. 8 is a sectional view showing a plane-to-line switching mode LCD according to an exemplary embodiment of the present invention.

Referring to FIG. 8, a plane-to-line switching (PLS) mode liquid crystal display 304 includes a first display substrate 104, a second display substrate 204, and a liquid crystal layer (not shown). The first display substrate 104 includes a first base substrate 110. Although not shown in FIG. 8, the first display substrate 104 may further include a black matrix and a color filter layer arranged on the first base substrate 110.

The second display substrate 204 includes a second base substrate 210, a common electrode 230, a first pixel electrode 221, and a second pixel electrode 222. The common electrode 230 is formed over the second base substrate 210, and an inter-insulating layer 235 is formed on the common electrode 230. The first pixel electrode 221 and the second pixel electrode 222 are formed on the inter-insulating layer 235. The first pixel electrode 221 and the second pixel electrode 222 are spaced apart from each other by a predetermined distance.

As shown in FIG. 8, a common voltage Vcom having a squarewave form, as shown in FIG. 2, is applied to the common electrode 230, a first data voltage Vd1 having a higher voltage level than that of the common voltage Vcom is applied to the first pixel electrode 221, and a second data voltage Vd2 having a lower voltage level than that of the common voltage Vcom is applied to the second pixel electrode 222.

Thus, a first fringe electric field in which the liquid crystal molecules are rotated by a voltage difference between the first data voltage Vd1 and the common voltage Vcom is generated between the first pixel electrode 221 and the common electrode 230. A second fringe electric field in which the liquid crystal molecules are rotated by a voltage difference between the second data voltage Vd2 and the common voltage Vcom is generated between the second pixel electrode 222 and the common electrode 230. Also, a lateral electric field in which the liquid crystal molecules are rotated by a voltage difference between the first data voltage Vd1 and the second data voltage Vd2 is generated between the first pixel electrode 221 and the second pixel electrode 222.

According to an exemplary embodiment of the display apparatus, the common voltage having the squarewave form that swings at every H/2 period is applied to the common electrode, the first data voltage is applied to the first pixel electrode during the earlier H/2 period among the 1H period, and the second data voltage having the opposite polarity to the polarity of the first data voltage is applied to the second pixel electrode during the later H/2 period among the 1H period.

Thus, the liquid crystal voltage applied to the liquid crystal layer interposed between the common electrode and the first and second pixel electrodes may be enhanced, thereby increasing the response speed of the liquid crystal and reducing the power consumption of the display apparatus.

Although exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display apparatus having a plurality of pixels to display an image,
each of the pixels comprising:
a common electrode receiving a common voltage having a squarewave form;
a first switching device outputting a first data voltage having a voltage level different from a voltage level of the common voltage in response to a first gate signal during an earlier H/2 period among a horizontal scanning period (1H) during which pixels connected to one row are turned on;
a second switching device outputting a second data voltage having a polarity different from a polarity of the first data voltage with reference to the common voltage in response to a second gate signal during a later H/2 period of the 1H period;
a first pixel electrode connected to an output electrode of the first switching device to receive the first data voltage;
a second pixel electrode electrically insulated from the first pixel electrode and connected to an output electrode of the second switching device to receive the second data voltage; and
a liquid crystal layer interposed between the common electrode and the first and second pixel electrodes.

2. The display apparatus of claim 1, wherein the voltage level of the common voltage is changed every H/2 period.

3. The display apparatus of claim 1, wherein a polarity of a first liquid crystal voltage applied to the liquid crystal layer during the earlier H/2 period is opposite to a polarity of a second liquid crystal voltage applied to the liquid crystal layer during the later H/2 period.

4. The display apparatus of claim 3, wherein the first liquid crystal voltage and the second liquid crystal voltage have a same absolute value.

5. The display apparatus of claim 1, wherein the first pixel electrode and the second pixel electrode are spaced apart from each other by a predetermined distance, and the common electrode is positioned in a region corresponding to a location between the first pixel electrode and the second pixel electrode.

6. The display apparatus of claim 5, wherein the common electrode has a width equal to or smaller than the predetermined distance between the first pixel electrode and the second pixel electrode.

7. The display apparatus of claim 5, wherein an opening is formed through the common electrode corresponding to the first pixel electrode and the second pixel electrode, and the common electrode has a width larger than the predetermined distance between the first pixel electrode and the second pixel electrode.

8. The display apparatus of claim 1, further comprising:
a first base substrate; and
a second base substrate facing the first base substrate.

9. The display apparatus of claim 8, wherein the common electrode is arranged on the first base substrate, and the first and second switching devices and the first and second pixel electrodes are arranged on the second base substrate.

10. The display apparatus of claim 9, wherein the first and second pixel electrodes are arranged on a same layer.

11. The display apparatus of claim 8, wherein the common electrode, the first and second switching devices, and the first and second pixel electrodes are arranged on either the first base substrate or the second base substrate.

12. The display apparatus of claim 11, wherein the first and second pixel electrodes are arranged on a same layer, and the common electrode is arranged on a different layer from a layer on which the first and second pixel electrodes are arranged so as to be insulated from the first and second pixel electrodes.

13. The display apparatus of claim 1, wherein each of the pixels further comprises:
a first gate line electrically connected to a control electrode of the first switching device to provide the first gate signal during the earlier H/2 period;
a second gate line electrically connected to a control electrode of the second switching device to provide the second gate signal during the later H/2 period; and
a data line electrically connected to an input electrode of the first switching device and an input electrode of the second switching device to provide the first data voltage and the second data voltage during the earlier H/2 period and the later H/2 period, respectively.
